(19) United States
(12) Patent Application Publication
(10) Pub. No.: US 2008/0151130 A1
(43) Pub. Date: Jun. 26, 2008

(54) Mobile Rendering Device and Method Providing Context Aware Power Saving

(75) Inventors: Jozef Pieter Van Gassel, Eindhoven (NL); Hendrikus Bernardus Van Den Brink, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/597,968

(22) PCT Filed: Feb. 3, 2005
(86) PCT No.: PCT/IB2005/050445

§ 371 Date: Aug. 15, 2006

(30) Foreign Application Priority Data
Feb. 17, 2004 (EP) 04100618.0

(51) Int. Cl. H04N 9/30

(52) U.S. Cl. 348/791

(57) ABSTRACT

A wireless detachable rendering device (1) having a display (10) and a wired network connection (14) to a data server (16) is equipped with a local storage means (11) such as a HDD. When device (1) is docked in a stand, data to be rendered on display is in a best-effort like fashion loaded via the wired connection into the storage means (11). Thus data is available for undocked use of device (1). Power consumption is reduced as use of the wireless connection is avoided.

This invention pertains in general to the field of rendering devices and more particularly to a portable or mobile rendering device with local storage, and even more particularly to power-saving strategies in such portable rendering devices having a wireless transmission of rendering data, wherein said rendering device is operable in various context situations.

Rendering devices, such as detachable LCD TVs, are devices similar to normal LCD TVs with an additional feature that allows the LCD display to be detached from its fixed mounting location, e.g. a stand or docking station positioned at a fixed mounting location, such as a living room, kitchen, etc. In this way the user can continue watching audio-visual material, such as movies, anywhere he or she likes within an area covered by a wireless network, e.g. within a house. While detached from the fixed stand, the audio and/or video will be sent over a wireless link, e.g. via IEEE 802.11, which is also called WiFi or Wireless Ethernet. For instance discloses WO 03/012607, a display of this type. The display is operable as a stand-alone device directly connected to a peripheral device without the need of an intermediate PC, and as well as a device connected to a fixed PC.

Wireless communication is a very expensive data retrieval means in terms of power consumption. Furthermore, the video material that is displayed needs to be compressed before it can be sent over the wireless link because of its limited bandwidth. The display itself also consumes a substantial amount of energy, mostly because of the backlight of the LCD. In addition, wireless links are not always reliable because of interference from other devices in the home that use the same frequency, e.g. other A/V devices, PCs but also microwave ovens. Moreover, the quality of the user experience is largely determined by the quality of the played-back video and the battery life. Thus, there is a need for a new way of ensuring a high quality of the play back video and enhanced battery life of portable or mobile rendering devices as described above.

The present invention overcomes the above-identified deficiencies in the art and solves at least the above-identified problems by providing a device and a method according to the appended independent patent claims. The dependent claims define advantageous embodiments of the invention.

The general solution according to the invention is as follows. The rendering device is equipped with a local storage device, such as a Hard Disk Drive (HDD). The capacity of the local storage device is preferably chosen to be sufficiently large enough to allow the entire content to be stored on the mobile rendering device. The rendering device is configured to receive content information either via a wired network connection or via a wireless network connection. The storage device allocates at least partly a storage area of said storage device in order to overcome the above-described limitations. Usually, the user starts playing back content, from e.g. a server device somewhere in the network, on the display of the rendering device. The related data, e.g. audio-visual data of a film, is via the wired connection copied simultaneously to the local storage device, with the highest transmission rate available, i.e. as fast as possible or in a best-effort like fashion. Optionally a wireless link via the wireless network connection, e.g. 802.11 a/g, is used for downloading data as fast as possible. In the case of using the wired network connection for the high speed-download, the rendering device is positioned at a fixed location, e.g. in its stand, cradle, docking station or the like. When the user detaches the rendering device from the fixed location, the audio-visual data is continued to be played from the local storage device. In the case of using the wireless link, the entire or remaining content is downloaded as fast as possible, then the wireless link is switched off and the content is only rendered from the data stored on the local storage device of the mobile rendering device.

The present invention has the advantage over the prior art that, owing to local storage, that it enables rendering devices to be portable without the need of an undue onboard power supply. The power consumption of a rendering device is reduced drastically, and the user experience is improved.

Further objects, features and advantages of the invention will become apparent from the following description of embodiments of the present invention, reference being made to the accompanying drawings, in which

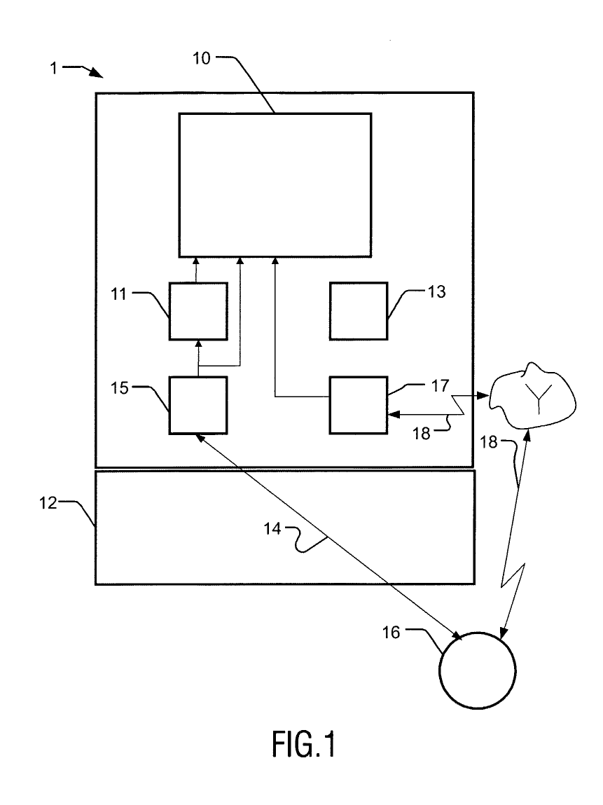

FIG. 1 is a schematic illustration of a device according to an embodiment of the invention; and

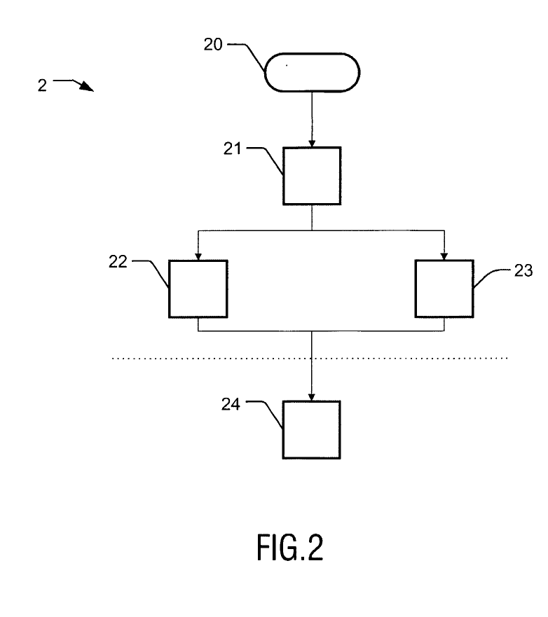

FIG. 2 is a flowchart illustrating a method according to an embodiment of the invention.

In an embodiment of the invention according to FIG. 1, a portable rendering device 1 is shown. The device 1 comprises a display monitor 10, such as a flatpanel LCD screen. Device 1 further comprises local storage means 11, such as a HDD, a re-writable optical disc as e.g. SFFO, or a solid-state memory. The device 1 comprising monitor 10 is detachable from a stand 12. The stand 12 serves among other things to charge the device's battery 13 and enables communication via wired communication means 15, such as an Ethernet network card, via a wired network 14 with a data server 16. Device 1 comprises furthermore wireless network communication means 17, such as a state-of-the art IEEE 802.11 transceiver, for wireless communication 18 with server 16. Both wired and wireless connections communicate with e.g. a central, interactive data server providing e.g. multimedia contents such as television-programmes or other audio-visual data.

Turning now to FIG. 2, the operation of the exemplary rendering device is elucidated below. At start 20 of method 2, it is assumed that device 1 is located in the stand 12 and is connected to the server via the wired network connection 14. In step 21 the device 1 requests a specific audio-visual content data from the network data server for rendering. The request is e.g. based upon user interaction or by timer initiation. In step 22 a copy of the data to be rendered is being downloaded via the wired portion 14 of the network 14, 18 and stored in the device's 1 local storage means 11. This is performed in parallel to rendering the received data on the screen 10, as illustrated by step 23. Thus, when the device 1 is positioned in the stand 12, and coupled to the wired network connection, a copy of the audio-visual data is stored during background action 22 in the device's local memory 11. Depending on parameters as the capacity of the storage means 11, the transmission rate via the network, etc., the data is either stored consecutively or stacked, i.e. the oldest data is replaced with the newest data. However, preferably the size of storage device 11 is chosen sufficiently large, such that sufficient storage capacity for data is available in all situations. More detailed, as soon as the user starts playing back content from a server device somewhere in the network on the display, the data is copied simultaneously to the local storage device 11 as fast as possible, i.e. in a best-effort like fashion, via the wired connection in its stand.

If the user then detaches the device 1 from the stand 12, the rendering does not have to rely on the wireless connection 18, as data to be rendered is stored locally in the device 1 on storage means 11. Hence, data is re-played without interruption on display 11, from storage means 12. In order to avoid having to send the data twice, the data is also in the stand played back from the local storage. Thus having to send the data twice is avoided. Therefore, the user may move around and use the rendering device 1 independently of a wireless network coverage area. The cached copy of the audio-visual data to be rendered also leads to lower power consumption, thus extending the battery's life. This is due to the fact that rendering data from a storage device is less power consuming than receiving the data via a wireless communication. Furthermore, as mentioned above, wireless communication via, e.g., IEEE 802.11, is typically susceptible to interference and blocking in addition to the fact that power consumption of wireless communication is a magnitude higher than that of wired communication.

Preferably, the device indicates to the user the battery status and the status of the downloaded content. Thus, the user is well informed and aware, that e.g. the device soon runs out data is or power, so that the user has to re-connect to a network or to recharge or replace the batteries of the device. Downloading the content to the local storage may continue through the wireless connection if the wireless connection is faster than the bit rate of the A/V data. Then the display can be detached even when the wired transmission is not completely finished. In fact, even in wireless mode it is energy saving to download the data fast compared to downloading small bits of the data at a time. So this still saves energy, and also makes the viewing robust against network disturbances.

Hence, by allocating a part or the entire storage area of the internal storage means for local access within the rendering device, the limitations of the prior art are overcome. Moreover, such smart synchronization strategy enhances the user experience by a high quality of the played-back video in combination with extended battery life, as energy consumption is reduced and disturbances of wireless communications are avoided. Therefore, the user does no longer have to rely on the bandwidth and quality of the wireless link, when the screen is detached from the stand. This also saves precious bandwidth for other devices. Experiments of the inventors have verified that the power consumption of retrieving data from a local storage device is an order of magnitude lower than sending it over WiFi, confirming the above. Thus a lot of energy can be saved by caching data on a local storage device, leading to the extended battery life. In addition, the battery of the display is charged when the device is in the stand. A further advantage is that the device does not need to stay in reach of a base station, e.g. integrated into the stand, and is thus truly mobile. This means that the user may e.g. take the device into the car and finish watching a film in the car.

In case the user removes the device from its fixed location such as from the stand, and the entire audio-visual content, which the user may want to see during the mobile phase, has not been downloaded yet, the wireless network may work as a back-up for downloading the remaining data of the content. However, in this case, the usage of the wireless communication network is to be limited to a minimum. This is preferably achieved by downloading the remaining data as fast as possible, i.e. by using the maximum available bandwidth of the wireless network. When the remaining data is downloaded to the local storage of the rendering device, the wireless network hardware of the device is switched off. In this manner, the energy consumption due to the usage of the wireless network is reduced to a minimum in comparison with the conventional way, where data is streamed on demand, i.e. for rendering in real-time on the display of the rendering device, directly from the received data. The reduction in energy consumption is based on the fact that sending one large chunk of data costs less energy than keeping a connection active over a longer period of time and downloading the data in small packets. Furthermore, this also protects against losing the wireless connection later, which is an undesired experience for the user as the rendering of data abruptly is interrupted. Thus even the reliability of the rendering device is enhanced.

Preferably, the user is notified by means of a special indicator, e.g. using an on-screen display, as soon as two key conditions are met. Firstly, the current status of the battery should allow play back of the entire or alternatively of the remainder of the audio-visual data from the local storage device. Secondly, the remainder of the content is transferred entirely to the local storage of the detachable display and available for mobile viewing. From that point on, the display may be detached and taken anywhere the user likes. This will guarantee that the user can finish play back without being disappointed.

Alternatively to downloading the remainder of a certain initiated audio-visual content, according to a variant of the above-described synchronization method, the detachable screen may proactively decide to transfer files to the local storage device comprised in the detachable rendering device, wherein these files are most likely to be watched in a later stage. This, for instance, may be based on preferences or usage profiling. For instance the latest news broadcast or a recording of a TV program that has been made the night before are stored on a HDD of a portable screen somewhere in the (wired) home network.

Optionally, the user may tick a ‘copy to display’ option when a program is scheduled to be recorded.

Applications and use of the invention described above by means of exemplary embodiments are various and include exemplary fields such as detachable or mobile displays, video jukeboxes, etc.

Furthermore, the present invention has been described above with reference to specific embodiments. However, other embodiments than the preferred above are equally possible within the scope of the appended claims, e.g. different types of displays, network standards, power sources than those described above, and/or performing the above method by hardware or software, etc.

Also, instead of a display, other means for reproducing data can be used like speakers, headphones and reading means for blind people.

Finally, the term “comprises/comprising” when used in this specification does not exclude other elements or steps, the terms “a” and “an” do not exclude a plurality and a single processor or other units may fulfil the functions of several of the units or circuits recited in the claims.

1. A method of saving power for a mobile rendering device, said method comprising the steps of:
when said rendering device is connected to a wired network:
a) downloading data via said wired network at a maximum available datarate, wherein said data being to be rendered on said mobile rendering device,
b) storing said data on a local storage means of said mobile rendering device,
c) rendering the received data from said local storage means for reproduction by said mobile rendering device; and
when said rendering device subsequently is solely connected to a wireless network or not connected to any network:
d) rendering said stored data from said storage means on said display means;
such that data transmission via a wireless network connection of said mobile rendering device is avoided when this is possible.

2. The method according to claim 1, further comprising after step d) a step of
e) continue downloading said data via said wireless connection at a maximum available datarate of said wireless network connection to said storage means.

3. The method according to claim 2, further comprising the step of switching off said wireless network connection upon finishing downloading said data to said local storage means, wherein said data comprises remaining data of a content to be rendered from said local storage means.

4. The method according to claim 1, further comprising the step of requesting said data to be received, wherein said requesting being based upon user interaction.

5. The method according to claim 1, further comprising the step of requesting said data to be received, wherein said requesting being based upon predetermined user preferences.

6. The method according to claim 1, further comprising the step of indicating the battery status and/or the status of the downloaded data.

7. The method according to claim 1, further comprising the step of recharging the battery of said device at said fixed location.

8. The method according to claim 1, said data being multimedia content.

9. The method according to claim 1, comprising performing the transition from step c) to step d) without interruption.

10. The method according to claim 1, comprising performing step c) simultaneously to steps a) and b).

11. The method according to claim 1, wherein
the mobile rendering device is positioned in a fixed location when connected to the wired network; and
used in a mobile environment when solely connected to the wireless network or not connected to any network at all.

12. A mobile rendering device (1) for performing the method of claim 1, said device (1) comprising
means (10) for reproducing data;
wireless network communication means (17), and
wired network communication means (15),
said means (10, 15, 17) being operatively connected to each other such that said device is adapted to receiving data via either a wireless network in a mobile environment, or via a wired network at a fixed location, from a remote data server for rendering on said display means (10),
said device (1) further comprising a storage means (11) for storing data received from said data server via said wired network (15) or via said wireless network (15), wherein received data in use is rendered on said means for reproducing data from data read from said storage means (11) at said fixed location and in said mobile environment.

13. The device according to claim 12, wherein said device (1) is a portable screen having a battery (13) being recharged at said fixed location.

14. The device according to claim 12, wherein said fixed location is a stand (12) for releasably receiving said device (1).

15. The device according to claim 12, wherein said device is a portable flatpanel television set.
